(19) United States
(12) Patent Application Publication
(10) Pub. No.: US 2009/0294486 A1
(43) Pub. Date: Dec. 3, 2009

(54) Bulk container with dual discharge outlets

(75) Inventors: Jacob T. McKnight, Houston, TX (US); Scott T. Meints, Houston, TX (US)

Correspondence Address: WOOD, PHILLIPS, KATZ, CLARK & MORTIMER, 500 W. MADISON STREET, SUITE 3800, CHICAGO, IL, 60661, US

(73) Assignee: Hoover Materials Handling Group, Inc.

(21) Appl. No.: 12/154,927

(22) Filed: May 28, 2008

(51) Int. Cl. B67D 5/08; B67D 5/06

(52) U.S. Cl. 222/482; 222/185.1

(57) ABSTRACT

A bulk container for storing and offloading materials comprises a portable tank including a sloped bottom wall with a first discharge outlet at a lowest level of the sloped bottom wall and a second discharge outlet at a higher level of the sloped bottom wall. A first outlet valve is connected to the first discharge outlet. A second outlet valve is connected to the second discharge outlet so that material above the higher level can be drained from the bulk container through the second outlet valve and residual material in the bulk container can be drained through the first outlet valve.

### CROSS REFERENCE TO RELATED APPLICATIONS

There are no related applications.

### FIELD OF THE INVENTION

The present invention relates to a bulk container and, more particularly, to dual discharge outlets in a bulk container.

### BACKGROUND OF THE INVENTION

Bulk packaging containers have found widespread use for storage and shipment of bulk goods. The bulk packaging containers assume many different forms. Among these forms are portable tanks and intermediate bulk containers (IBC). Requirements for these types of containers are outlined in various D. O. T. and F. D. A. regulations and are particularly defined in 49CFR Section 171.8.

Among IBCs, there include numerous types of designs. These include metal IBCs, which are constructed of metal, rigid plastic IBCs which are constructed of all-plastic material, and composite IBCs which include a rigid outer package enclosing a plastic inner receptacle.

An IBC typically has a capacity in the range of 250-550 gallons. Some are as large as 793 gallons. As such, they are an efficient alternative to 55-gallon drums. Nevertheless, each IBC must be handled and transported individually when used, for example, in the export of materials. The IBC is typically loaded into a shipping vessel. Each IBC must be individually slung by a crane or carried by a forklift during the loading and unloading.

Typically, an IBC is filled through a top fill opening. Discharge is provided through a bottom opening defining a discharge outlet. Complete drainage of the IBC is desirable to avoid waste. An IBC may be used, for example, to store and transport jet fuel. The jet fuel may contain water which remains in the fuel upon discharge. Advantageously, the IBC would provide separate drainage for jet fuel and water in the jet fuel.

The present invention is directed to an a dual discharge outlet in a bulk container for separately draining different materials from the IBC.

### SUMMARY OF THE INVENTION

In accordance with the invention, there is provided a bulk container with dual discharge outlets.

In accordance with one aspect of the invention, there is disclosed an improvement in a bulk container for storing materials and including a sloped bottom wall. The improvement comprises a first discharge outlet at a lowest level of the sloped bottom wall and a second discharge outlet at a higher level of the sloped bottom wall. First and second outlet valves are connected to the respective first and second discharge outlets. Material above the higher level can be drained from the bulk container through the second outlet valve and residual material in the bulk container can be drained through the first outlet valve.

It is a feature of the invention to provide a first elbow connected between the first discharge outlet and the first outlet valve at a second elbow connected between the second discharge outlet and the second outlet valve.

It is a further feature of the invention that the second elbow has an upper edge defining an inlet spaced upwardly from the sloped bottom wall. The first elbow has an upper edge defining an inlet substantially flush with the sloped bottom wall.

It is another feature of the invention that the second elbow comprises a sweep elbow.

It is a further feature of the invention that the second elbow upper edge is spaced in the range of about 3 to 5 inches above the first discharge outlet and may advantageously be about 4 inches above the first discharge outlet.

There is disclosed in accordance with another aspect of the invention, an apparatus comprising a bottom head including a sloped bottom wall turned upwardly to a peripheral edge for connection to a tank. A first discharge outlet is at a lowest level of the sloped bottom wall. A second discharge outlet is at a higher level of the sloped bottom wall. First and second outlet valves are connected to the respective first and second discharge outlets. Material above the higher level can be drained through the second outlet valve and residual material can be drained through the first outlet valve.

There is disclosed in accordance with another aspect of the invention, a bulk container for storing materials comprising a tank. The bulk container includes a sloped bottom wall with a first discharge outlet at a lowest level of the sloped bottom wall and a second discharge outlet at a higher level of the sloped bottom wall. A first outlet valve is connected to the first discharge outlet. A second outlet valve is connected to the second discharge outlet. Material above the higher level can be drained from the bulk container through the second outlet valve and residual material in the bulk container can be drained through the first outlet valve.

Further features and advantages of the invention will be apparent from the specification and the drawings.

### BRIEF DESCRIPTION OF THE DRAWINGS

FIG. 1 is a bottom plan view of an intermediate bulk container (IBC) including a thermal trip stop valve in accordance with the invention;

FIG. 2 is a front elevation view of the IBC of FIG. 1;

FIG. 3 is a side elevation view of the IBC of FIG. 1;

FIG. 4 is an enlarged side elevation view, similar to FIG. 3, with parts removed for clarity;

FIG. 5 is a sectional view taken along line 5-5 of FIG. 4; and

FIG. 6 is a sectional view taken along the line 6-6 of FIG. 4.

### DETAILED DESCRIPTION OF THE INVENTION

The present invention relates generally to dual discharge outlets used, for example, on the bottom wall of a portable tank, or an intermediate bulk container (IBC), or the like, for transporting and storing materials, such as liquid materials. 49CFR Section 171.8 defines a portable tank as a “bulk packaging (except a cylinder having a water capacity of 1000 pounds or less) designed primarily to be loaded onto, or on, or temporarily attached to a transport vehicle or ship and equipped with skids, mountings, or accessories to facilitate handling of the tank by mechanical means.” An IBC is defined as “a rigid or flexible portable packaging, other than a cylinder or portable tank, which is designed for mechanical handling.” Particularly, the dual discharge outlets used on an IBC or portable tank, or the like, with other appurtenances, aids in allowing water in, for example jet fuel, to settle to the bottom of the tank to be drained separately from the jet fuel. The present invention is described relative to an IBC. However, the principals of the invention can be applied to portable tanks and the like and may be referred to herein more generally as a bulk container.

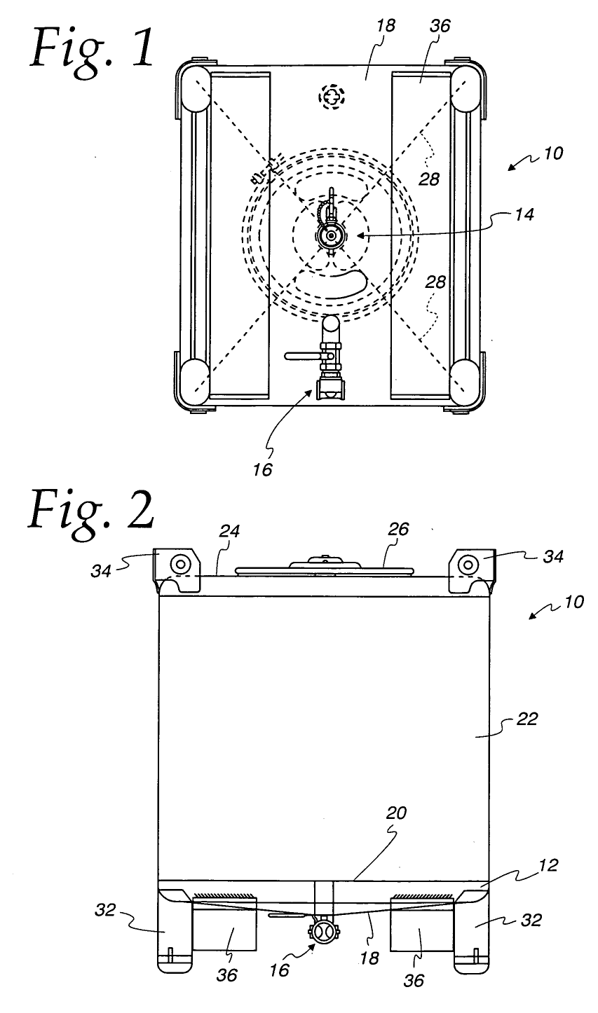

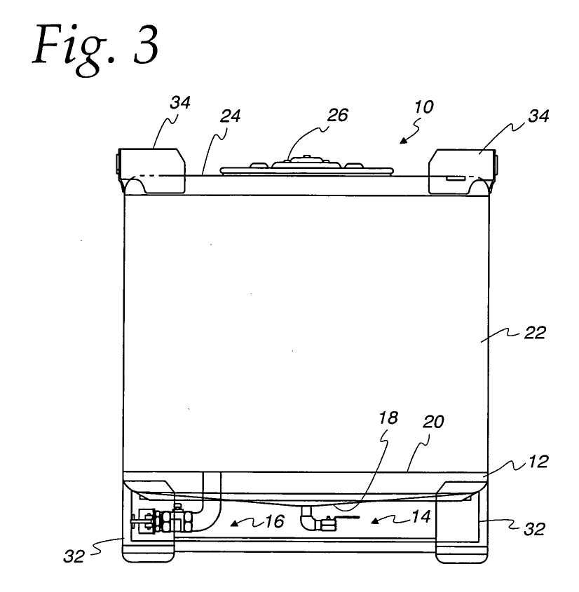

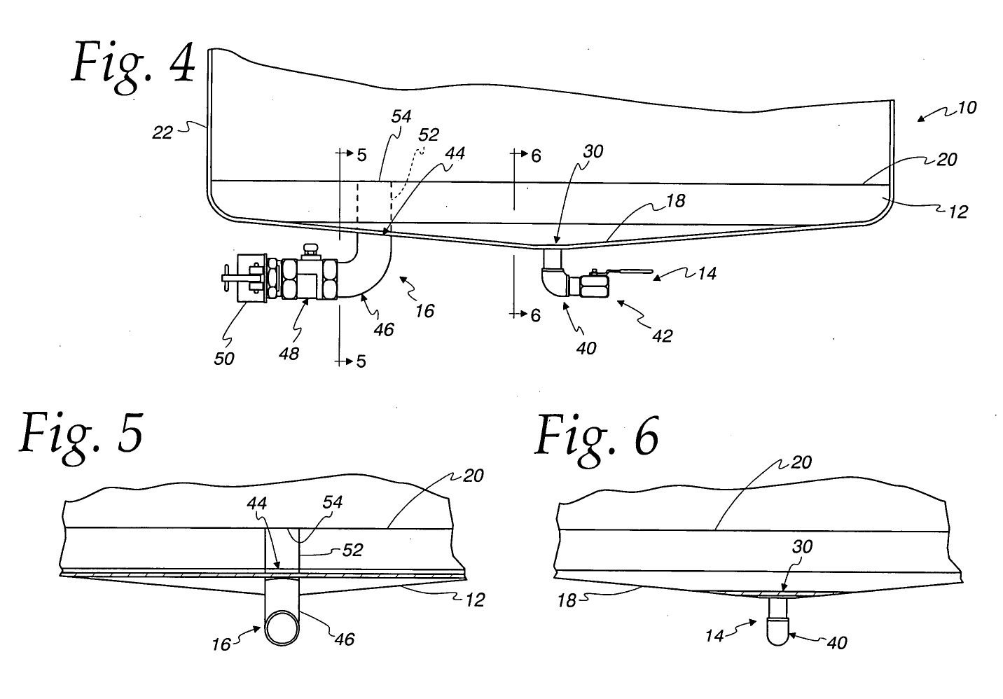

Referring to FIGS. 1-3, a portable tank, in the form of an IBC 10, includes a bottom head 12, see also FIG. 4, equipped with dual discharge assemblies 14 and 16.

The IBC bottom head 12 comprises a formed, sloped bottom wall 18, turned upwardly to define a peripheral edge 20. The peripheral edge 20 defines a bottom weld seam where the bottom head 12 is welded to a peripheral side wall 22 of the tank which is closed by a top wall 24. The top wall 24 includes a fill opening (not shown) closed by a cover 26. The bottom wall 18 includes creases, shown by dashed lines 28, so that the bottom wall 18 slopes towards a first discharge outlet 30. Four formed legs 32 are provided at each corner of the bottom head 12 to support the IBC 10 on a support surface or for stacking on another IBC. Lifting lugs 34 are provided at each corner of the top wall 24. Formed, two-way fork channels 36 extend longitudinally under the bottom head 12 for transporting using a fork lift device.

In the illustrated embodiment of the invention, the dual discharge outlets are shown on an IBC 10 manufactured and sold by the assignee of the present invention under the trademark LIQUITOTE®. The LIQUITOTE® IBC is a steel container typically providing capacity in the range of 255 to 550 gallons, although some are as large as 793 gallons, and has a nominal width of 42 inches and nominal length of either 42 or 48 inches. The capacity is otherwise determined by height of the container, which is variable. Although the dual discharge outlets are illustrated on the LIQUITOTE® IBC, the dual discharge outlets could be used with other types of IBCs, portable tanks, or the like, as will be apparent skilled in the art. Such containers may provide capacity in the range of 120 to 793 gallons. Also, the IBC could be manufactured of rigid plastic or be of composite construction, as is known. As used herein, the term bulk container is intended to also refer more generally to IBCs and portable tanks, ort eh like.

The first discharge outlet 30 comprises an opening at a lowest level of the sloped bottom wall 18, as illustrated. Referring to FIGS. 4-6, a first elbow 40 is welded to the bottom head 12 at the first discharge outlet 30. The first elbow 40 may be of one piece construction or may comprise one or more nipples connected to a 90° elbow. The first elbow 40 is in turn connected to a one inch water release valve 42 of conventional construction. Thus, the first discharge assembly 14 comprises the first elbow 40 and water release valve 42 operatively associated with the first discharge outlet 30.

The second discharge assembly 16 comprises a second discharge outlet 44 in the bottom wall 18 at a level higher than that of the first discharge outlet 30. A second elbow 46 is welded to the bottom wall 18 at the second discharge outlet 44. The second elbow is connected to a ball valve 48 of conventional instruction including a quick connect adaptor for connecting to a dust cap 50 or an external hose (not shown).

The second discharge assembly 16 may comprise a pipe extension 52 welded to the second discharge outlet 44 and which extends up toward the level of the bottom weld seam 20. In the illustrated embodiment of the invention, the pipe 52 has an upper edge 54 spaced upwardly from the sloped bottom wall 18 and may be substantially flush with the weld seam 20.

Although the second elbow 46 and pipe 52 are described as separate components, the pipe 52 could be simply an extension of the second elbow 46, as will be apparent to those skilled in the art.

In accordance with the invention, the second elbow 46 may comprise a sweep elbow as described in U.S. patent application Ser. No. 11/906,229, filed Oct. 1, 2007, owned by the Assignee of the present application, the specification of which is hereby incorporated by reference herein. As described therein, the sweep elbow 46 has a bottom interior surface proximate a sweep elbow outlet substantially even with a valve opening inside the outlet valve.

In an exemplary embodiment of the invention, the bottom weld seam 20 is spaced approximately 2½ inches above an uppermost portion of the bottom wall 18. The bottom wall 18 has a 1½ inch slope. The pipe 52 is approximately 3⅛ inch long. As such, the pipe upper edge 54 of the second discharge assembly 16 is about 4 inches above the first discharge outlet 30. As is apparent, this spacing could be different and advantageously would be in the range of about 3 inches to 5 inches.

The IBC 10 disclosed herein is advantageously used for storing and transporting jet fuel. As is apparent, water in the jet fuel will settle to the bottom of the tank 10. This water is captured in the bottom head 12 below the second discharge assembly inlet defined by the pipe upper edge 54. As such, the second discharge assembly 16 is used to advantageously drain 100% fuel from the tank 10. As is apparent, the second discharge assembly 16 will only drain material that is above the pipe upper edge 54. Thereafter, the first discharge assembly 14 can be used to drain residual material, which in the described example, comprises water from the jet fuel which has settled to the bottom of the tank. As is further apparent, the height of the second discharge assembly upper edge 54 can be selected based on an anticipated amount of water contained in the jet fuel, as it is desired to minimize any waste of jet fuel, while also eliminating as much water as possible.

Thus, in accordance with the invention, there is described a bulk container including dual discharge outlets for draining separated materials from the bulk container.

I claim:

1. In a bulk container for storing materials and including a sloped bottom wall, the improvement comprising:
a first discharge outlet at a lowest level of the sloped bottom wall and a second discharge outlet at a higher level of the sloped bottom wall, and first and second outlet valves being connected to the respective first and second discharge outlets so that material above the higher level can be drained from the bulk container through the second outlet valve and residual material in the bulk container can be drained through the first outlet valve.

2. The improvement of claim 1 further comprising a first elbow connected between the first discharge outlet and the first outlet valve and a second elbow connected between the second discharge outlet and the second outlet valve.

3. The improvement of claim 2 wherein the second elbow has an upper edge defining an inlet spaced upwardly from the sloped bottom wall.

4. The improvement of claim 3 wherein the first elbow has an upper edge defining an inlet substantially flush with the sloped bottom wall.

5. The improvement of claim 2 wherein the second elbow comprises a sweep elbow.

6. An apparatus comprising a bottom head including a sloped bottom wall turned upwardly to a peripheral edge for connection to a tank, a first discharge outlet at a lowest level of the sloped bottom wall and a second discharge outlet at a higher level of the sloped bottom wall, and first and second outlet valves being connected to the respective first and second discharge outlets so that material above the higher level can be drained through the second outlet valve and residual material can be drained through the first outlet valve.

7. The apparatus of claim 6 further comprising a first elbow connected between the first discharge outlet and the first outlet valve and a second elbow connected between the second discharge outlet and the second outlet valve.

8. The apparatus of claim 7 wherein the second elbow has an upper edge defining an inlet spaced upwardly from the sloped bottom wall.

9. The apparatus of claim 8 wherein the first elbow has an upper edge defining an inlet substantially flush with the sloped bottom wall.

10. The apparatus of claim 8 wherein the second elbow upper edge is substantially flush with the peripheral edge.

11. The apparatus of claim 6 wherein the second elbow comprises a sweep elbow.

12. A bulk container for storing materials comprising:
a tank including a sloped bottom wall with a first discharge outlet at a lowest level of the sloped bottom wall and a second discharge outlet at a higher level of the sloped bottom wall;
a first outlet valve connected to the first discharge outlet; and
a second outlet valve connected to the second discharge outlet, so that material above the higher level can be drained from the bulk container through the second outlet valve and residual material in the bulk container can be drained through the first outlet valve.

13. The bulk container of claim 12 further comprising a first elbow connected between the first discharge outlet and the first outlet valve and a second elbow connected between the second discharge outlet and the second outlet valve.

14. The bulk container of claim 13 wherein the second elbow has an upper edge defining an inlet spaced upwardly from the sloped bottom wall.

15. The bulk container of claim 14 wherein the second elbow upper edge is spaced in a range of about 3 to 5 inches above the first discharge outlet.

16. The bulk container of claim 14 wherein the second elbow upper edge is spaced about 4 inches above the first discharge outlet.

17. The bulk container of claim 14 wherein the first elbow has an upper edge defining an inlet substantially flush with the sloped bottom wall.

18. The bulk container of claim 14 wherein the second elbow comprises a sweep elbow.

19. The bulk container of claim 12 wherein the bottom wall is sloped toward the first discharge outlet.

20. The bulk container of claim 12 wherein the tank comprises a tank having a capacity in the range of about 120 to 793 gallons.
